(19) United States
(12) Patent Application Publication
(10) Pub. No.: US 2026/0157835 A1
(43) Pub. Date: Jun. 11, 2026

(54) ORAL CLEANER AND DRIVING APPARATUS FOR ORAL CLEANING

(71) Applicant: Shenzhen Soocas Technology Co., Ltd., Shenzhen (CN)

(72) Inventors: Yi XIE, Shenzhen (CN); Yanqiang LI, Shenzhen (CN); Mengwei ZENG, Shenzhen (CN)

(73) Assignee: Shenzhen Soocas Technology Co., Ltd., Shenzhen (CN)

(21) Appl. No.: 19/428,384

(22) Filed: Dec. 22, 2025

Related U.S. Application Data
(63) Continuation of application No. PCT/CN2025/114249, filed on Aug. 13, 2025.

(30) Foreign Application Priority Data
Dec. 9, 2024 (CN) 2024117983348

(51) Int. Cl. A61C 17/22; A61C 17/34

(52) U.S. Cl. CPC A61C 17/227; A61C 17/221; A61C 17/3436

(57) ABSTRACT

The present application discloses an oral cleaner and a driving apparatus for oral cleaning. The oral cleaner includes a brush handle assembly and a nursing head, the brush handle assembly includes a grip housing and a driving apparatus, the driving apparatus at least includes a static component and a rotary component, the static component includes a shell element and a stator bracket accommodated in the shell element, an inner wall surface of the stator bracket is provided with a plurality of accommodating tooth grooves, and an extending direction of the accommodating tooth grooves is parallel to a first axis; the rotary component includes a power output shaft and at least two rotor assemblies located within the stator bracket, the at least two rotor assemblies sleeve the power output shaft and are sequentially stacked along the first axis.

### CROSSREFERENCE TO RELATED APPLICATION

The present application is a continuation of International Application No. PCT/CN2025/114249, filed on Aug. 13, 2025, which claims priority to Chinese patent application No. 2024117983348, entitled “Oral Cleaner and Driving Apparatus for Oral Cleaning”, filed on Dec. 9, 2024, the entire content of which is incorporated herein by reference.

### TECHNICAL FIELD

The present application relates to the field of oral cleaning appliances, and in particular, to an oral cleaner and a driving apparatus for oral cleaning.

### BACKGROUND

An electric toothbrush typically includes a brush handle assembly and a brush head connected with the brush handle assembly, and a user grips the brush handle assembly to move the brush head and cooperates with a servo motor in the brush handle assembly to drive the brush head to move, so as to realize deep cleaning of the oral cavity.

However, due to a limitation of a volume of the brush handle assembly, the brush handle assembly cannot accommodate more batteries, such that the servo motor can only be driven at a low voltage, but the servo motor driven at the low voltage has weak power and a poor anti-load capacity, which results in a poor cleaning effect.

### SUMMARY

An objective of the present application is to provide an oral cleaner and a driving apparatus for oral cleaning.

In order to achieve the above objective, in an aspect, the present application provides an oral cleaner, including a brush handle assembly and a nursing head, wherein the brush handle assembly includes a grip housing having an accommodating space as well as a driving apparatus and an energy storage component which are arranged in the accommodating space, and the nursing head has a cleaning portion at a distal end thereof; the brush handle assembly is removably coupled with the nursing head; the driving apparatus is configured to generate a periodic motion; the driving apparatus extending along a first axis at least includes a static component and a rotary component, the static component includes a shell element and a stator bracket accommodated in the shell element, an inner wall surface of the stator bracket is provided with a plurality of accommodating tooth grooves arranged around the first axis, and an extending direction of the accommodating tooth grooves is parallel to the first axis; the rotary component includes a power output shaft and at least two rotor assemblies located within the stator bracket, and the power output shaft is at least partially contained within the brush handle assembly and configured to be engaged with the nursing head; the power output shaft is configured to transmit the generated periodic motion to the nursing head, such that the cleaning portion rotates periodically at least in a first direction, and the first direction is around the first axis; the power output shaft extends along the first axis and is rotatably connected with the shell element, the at least two rotor assemblies sleeve the power output shaft and are sequentially stacked along the first axis, and every two adjacent rotor assemblies have a preset staggering angle when viewed from a section perpendicular to the first axis.

In order to achieve the above objective, in another aspect, the present application further provides a driving apparatus for oral cleaning, at least including: a static component extending along a first axis and including a shell element and a stator bracket accommodated in the shell element, wherein an inner wall surface of the stator bracket is provided with a plurality of accommodating tooth grooves arranged around the first axis, and an extending direction of the accommodating tooth grooves is parallel to the first axis; and a rotary component including a power output shaft and at least two rotor assemblies located within the stator bracket, wherein the power output shaft extends along the first axis and is rotatably connected with the shell element, the at least two rotor assemblies sleeve the power output shaft and are sequentially stacked along the first axis, and every two adjacent rotor assemblies have a preset staggering angle when viewed from a section perpendicular to the first axis.

In order to achieve the above objective, in another aspect, the present application further provides a brush handle assembly, including a grip housing having an accommodating space, wherein an energy storage component and the above driving apparatus for oral cleaning are arranged in the accommodating space.

### BRIEF DESCRIPTION OF THE DRAWINGS

To describe the technical solutions of the embodiments of the present application more clearly, the following briefly describes the accompanying drawings required for describing the embodiments. Apparently, the accompanying drawings in the following description only show some embodiments of the present application, and a person of ordinary skill in the art may still derive other drawings from these accompanying drawings without creative efforts.

FIG. 1 is a schematic structural diagram of an oral cleaner according to an embodiment of the present application;

FIG. 2 is a schematic semi-sectional diagram of a driving apparatus according to an embodiment of the present application;

FIG. 3 is a schematic sectional diagram of a part of a structure of a static component in an embodiment of the present application;

FIG. 4 is a schematic semi-sectional diagram of a rotary component in an embodiment of the present application;

FIG. 5 is a schematic structural diagram of the rotary component in an embodiment of the present application;

FIG. 6 is a schematic sectional diagram of the rotary component in an embodiment of the present application;

FIG. 7 is a schematic diagram of a staggered pole structure of a rotor assembly in an embodiment of the present application;

FIG. 8 is a schematic diagram of the staggered pole structure of the rotor assembly in another embodiment of the present application;

FIG. 9 is a schematic diagram of the staggered pole structure of the rotor assembly in still another embodiment of the present application;

FIG. 10 is a schematic enlarged diagram of a part of the structure of FIG. 2;

FIG. 11 is a schematic enlarged diagram of a part of a structure of the driving apparatus according to an embodiment of the present application; and

FIG. 12 is a schematic semi-sectional diagram of the driving apparatus according to another embodiment of the present application.

### REFERENCE NUMERALS

1000: brush handle assembly; 2000: nursing head; 2100: fluid channel; 2200: outflow opening; a: first axis; θk: preset staggering angle;
100: grip housing; 110: accommodating space;
200: driving apparatus; 210: shell element; 211: shell body; 212: tail cover; 220: stator bracket; 221: accommodating tooth groove; 230: power output shaft; 231: axial channel; 232: output shaft body; 233: transmission shaft; 240: rotor assembly; 241: rotor bracket; 2411: base; 24111: mounting hole; 2412: positioning rib part; 242: first magnetic part; 243: second magnetic part; 244: magnet groove; 250: motion detection assembly; 260: motion feedback assembly; 261: mounting base; 2611: sleeve; 2612: support backing plate; 262: position feedback part; 270: surface covering element; 271: joining portion; 280: tensioning part;
300: energy storage component;
400: liquid storage chamber;
500: fluid pumping unit.

### DETAILED DESCRIPTION

With an improvement of a living standard of people, oral cavities begin to be cleaned by means of various oral cleaners in more and more families, and tools, such as electric toothbrushes, oral irrigators and irrigation-brushing all-in-one machines, are configured to assist in cleaning to improve an oral environment. Taking the electric toothbrush as an example, the electric toothbrush typically includes a brush handle assembly and a brush head connected with the brush handle assembly, and a user grips the brush handle assembly to move the brush head and cooperates with a servo motor in the brush handle assembly to drive the brush head to move, so as to realize deep cleaning of the oral cavity using high-frequency forward and reverse rotation and high control precision of the servo motor.

In the related art, the servo motor in the brush handle assembly can be driven at a low voltage (usually a single battery, 3.7-4.2v) or high voltage (two or more batteries, 7.4v). If the servo motor is driven at the low voltage, a requirement for a power source is low, the servo motor can be driven by the single battery, but the servo motor has weak power, a weak anti-load capacity and a poor cleaning effect. Therefore, in order to enhance power, the present applicant attempted to use the high voltage to drive the servo motor, that is, use two batteries for driving, which increases the power of the servo motor, but also results in an increase of a volume of the brush handle assembly for accommodating the two batteries, which affects a grip feeling and portability of the user, and reduces use experience of the user.

Therefore, the present applicant changed a research direction and explored how to increase the power and the anti-load capacity of the driving apparatus under the condition of keeping the volume of the brush handle assembly, so as to improve the oral cleaning effect. Specifically, during in-depth study of power influence factors of the servo motor driven at the low voltage, the applicant found that in the servo motor used by the electric toothbrush in the current market, a rotor magnetic pole adopts the design mode that even partitioning is performed circumferentially, and meanwhile, partitioning is not performed axially, and a stator straight groove is adopted, and during running of the motor, due to existence of an iron core tooth groove, a permanent magnet on a rotor and a stator iron core can interact, such that the motor can generate cogging torque when rotating, a part of the power of the servo motor is required to overcome the cogging torque during a reciprocating motion, and therefore, the servo motor has weak power and a poor anti-load capacity, thereby affecting the oral cleaning effect.

Based on this, the applicant designed rotor and stator structures of the servo motor. Specifically, a rotor oblique pole-like structure is realized through a segmented straight pole staggered design, and specific subharmonics are weakened in cooperation with the design of the stator straight groove, such that the cogging torque of the motor is weakened, and then, the output power and the anti-load capacity of the servo motor are improved without additionally increasing the battery to change the volume of the brush handle assembly, thereby improving the cleaning effect.

In addition, the present applicant also found that generation of the cogging torque can also cause the servo motor to vibrate. An existing Hall sensor is arranged outside a body of the servo motor, mounting is not stable enough, mounting precision is insufficient, and along with the vibration of the servo motor, precision of detection of a moving position of the rotor by the Hall sensor is further influenced, and a control effect on a cleaning motion of the electric toothbrush is reduced, thereby affecting the use experience of the user.

Based on this, the applicant redesigned mounting positions and mounting modes of a circuit board of the Hall sensor and a magnetic ring on the basis of weakening the cogging torque. Specifically, in the design, the circuit board of the Hall sensor is directly connected with a static part of the servo motor, the structure simplifies an assembly process, mounting can be completed only by one operation, assembly complexity is obviously reduced, and assembly precision is improved. The modification guarantees a precise arrangement of the circuit board of the Hall sensor and is beneficial to improving the motion control effect. Furthermore, the circuit board of the Hall sensor and the magnetic ring are arranged in the motor assembly, such that expansion of an external structure is avoided, thus reducing an overall size of the motor to realize a more compact miniaturized design. The compact structure not only can make the electric toothbrush slimmer to optimize an aesthetic degree of the electric toothbrush, but also can reserve a larger water storage space in the electric toothbrush to contain more irrigation-brushing liquid, thereby enhancing integral functionality of a product.

To make the objectives, technical solutions and advantages of the embodiments of the present application clearer, the technical solutions in the embodiments of the present application are clearly and completely described with reference to the accompanying drawings in the embodiments of the present application, and apparently, the described embodiments are not all but a part of the embodiments of the present application.

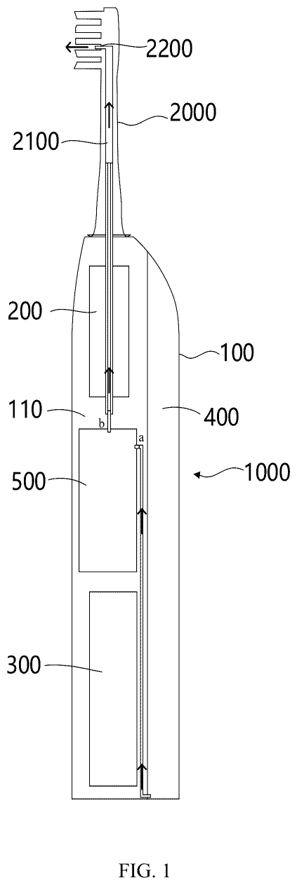

As shown in FIG. 1, the present application provides an oral cleaner that can include a brush handle assembly 1000 and a nursing head 2000, the nursing head 2000 having a cleaning portion at a distal end thereof, and the brush handle assembly 1000 being removably coupled with the nursing head 2000. The brush handle assembly 1000 includes a grip housing 100, a driving apparatus 200 and an energy storage component 300, the energy storage component 300 is configured to supply electric energy to the driving apparatus 200 to drive the driving apparatus 200 to run, and the user can hold the grip housing 100 with a hand to drive the oral cleaner to move for cleaning. The grip housing 100 has an accommodating space 110, the driving apparatus 200 and the energy storage component 300 are arranged in the accommodating space 110, and the driving apparatus 200 is configured to drive the nursing head 2000.

It should be noted that the oral cleaner may be a cleaning device only having a brushing function, and it may only perform brushing cleaning of the oral cavity of the user, such as an electric toothbrush. The oral cleaner may also be a cleaning device integrating brushing and irrigation functions, it can perform brushing cleaning, irrigation cleaning or both brushing cleaning and irrigation cleaning of the oral cavity of the user, such as an irrigation-brushing all-in-one machine, and the application has no limitations in this respect.

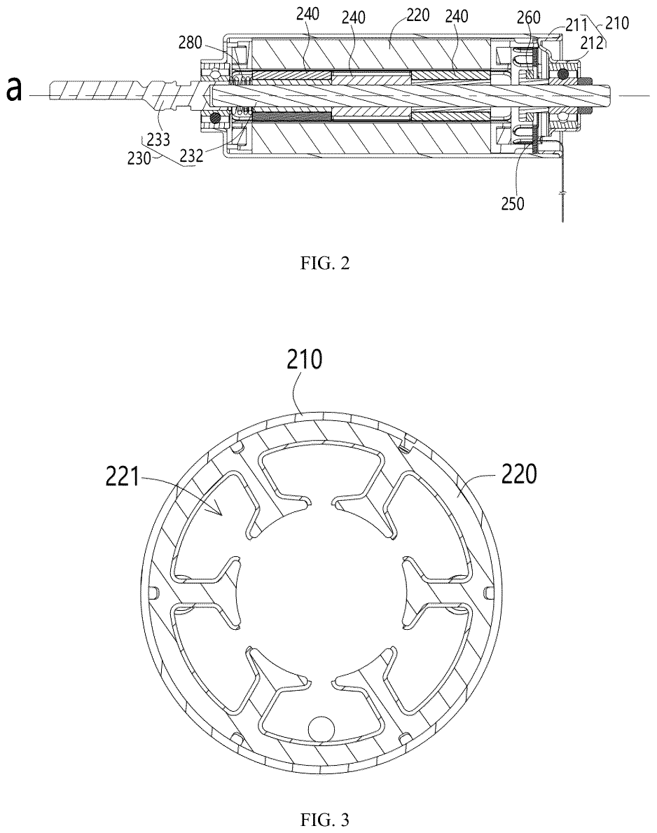

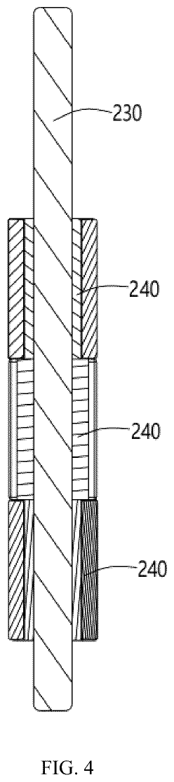

As shown in FIGS. 2 to 6, in an implementable embodiment, the driving apparatus 200 is configured to convert electric energy into mechanical energy to generate a periodic motion, such as a high frequency vibration and/or a reciprocating swing. The driving apparatus 200 may be configured in a cylindrical shape, and a first axis a is a center line of the driving apparatus 200; that is, center points of cross sections of the driving apparatus 200 may be located on the first axis a, and the driving apparatus 200 extends along the first axis a. The driving apparatus 200 may include a static component and a rotary component, and when the driving apparatus 200 moves, the static component remains relatively static, and the rotary component rotates relative to the static component, thereby driving the nursing head 2000 to move.

In the present embodiment, the static component may include a shell element 210 and a stator bracket 220, the stator bracket 220 being accommodated in the shell element 210, an inner wall of the stator bracket 220 being provided with a plurality of accommodating tooth grooves 221 arranged around the first axis a, and the accommodating tooth grooves 221 being configured to accommodate coils. In practical applications, the shell element 210 may include a shell body 211 and a tail cover 212. The tail cover 212 is arranged at an end of the shell body 211 along the first axis a. The shell body 211 is configured in a cylindrical structure, an axis of the shell body 211 may be collinear with the first axis a, and an opening is formed in one end of the shell body 211, such that the stator bracket 220 and the rotary component can be conveniently mounted into the shell body 211 through the opening. The tail cover 212 is connected with the shell body 211 and at least partially covers the opening to avoid that foreign objects enter the shell body 211 to affect normal running of the driving apparatus 200.

The rotary component may include a power output shaft 230 and a rotor element, the power output shaft 230 being at least partially contained within the brush handle assembly 1000 and configured to be engaged with the nursing head 2000. The power output shaft 230 is configured to transmit the generated periodic motion to the nursing head 2000, such that the cleaning portion is periodically rotated at least in a first direction, the first direction being around the first axis a. That is, the power output shaft 230 performs reciprocating rotation with the first axis a as a rotation center line. Certainly, the power output shaft 230 may have other movement forms, such as axial reciprocating movement along the first axis a, tapping movement in a direction perpendicular to the first axis a, or a combination of several movement forms. The power output shaft 230 extends along the first axis a, and the power output shaft 230 is rotatably connected with the shell element 210 and has at least one end extending out of the shell element 210 for a connection with the nursing head 2000. The rotor element is fixedly connected with the power output shaft 230 and located in a region defined by the stator bracket 220, and the rotor element is configured to interact with a rotating magnetic field generated by the coil on the stator bracket 220, such that the rotor element and the rotating magnetic field rotate synchronously to drive the power output shaft 230 to rotate to output rotating power.

An oblique pole structure can be formed by inclining the accommodating tooth groove 221 or the rotor element, such that a cogging torque period is increased, and a cogging torque amplitude is reduced, thereby weakening cogging torque, reducing an acting force of the driving apparatus 200 for overcoming the cogging torque, increasing actual output power of the driving apparatus 200, then improving the output power and an anti-load capacity of the driving apparatus 200 without additionally increasing a number of the energy storage components 300 to change a volume of the brush handle assembly 1000, and improving an oral cleaning effect.

The coil needs to be wound around the stator bracket 220, which is inconvenient for implementation of the oblique structure through a segmented design, and overall inclining of the accommodating tooth groove 211 has high machining difficulty and a high machining cost.

Therefore, in the present application, preferably, an oblique pole-like structure is implemented by performing segmented straight pole staggering on the rotor element, so as to improve the output power and the anti-load capacity of the driving apparatus 200. Specifically, an extending direction of the accommodating tooth groove 221 is parallel to the first axis a, that is, the accommodating tooth groove 221 adopts a straight groove design. Correspondingly, the rotor element is at least two rotor assemblies 240, the at least two rotor assemblies 240 sleeve the power output shaft 230 and are sequentially stacked along the first axis a, and when viewed from a section perpendicular to the first axis a, every two adjacent rotor assemblies 240 have a preset staggering angle θk. In other words, in the present application, the rotor element is divided into multiple rotor assemblies 240 along the first axis a, and every two adjacent rotor assemblies 240 are butted in a staggered manner. In this way, the oblique pole-like structure may be formed by performing segmented straight pole staggering on the rotor element, so as to improve the output power and the anti-load capacity of the driving apparatus 200. Meanwhile, the accommodating tooth groove 221 has a straight groove structure, which facilitates winding of the coil, and the rotor element is divided into a plurality of staggered segments, thus facilitating machining and assembling operations, and reducing a manufacturing cost.

Segmented straight pole staggering is performed on the rotor elements to form the oblique pole-like structure, such that vibrations generated by the driving apparatus can be reduced to avoid that the vibrations of the driving apparatus affect control precision of a motion detection component, thereby making a control system of the driving apparatus more stable, accurate and efficient, then guaranteeing running stability of the nursing head, and improving use experience of a user.

In practical applications, each rotor assembly 240 includes a rotor bracket 241, a first magnetic part 242 and a second magnetic part 243, the first magnetic part 242 and the second magnetic part 243 have opposite magnetism, and the first magnetic part 242 and the second magnetic part 243 are arranged along a circumferential direction of the rotor bracket 241. After every two adjacent rotor assemblies 240 are butted in the staggered manner, projections of the first magnetic parts 242 of the two adjacent rotor assemblies 240 along the direction parallel to the first axis a are partially overlapped, that is, do not completely coincide, and projections of the second magnetic parts 243 of the two adjacent rotor assemblies 240 along the direction parallel to the first axis a are partially overlapped. During assembly, the first magnetic part 242 and the second magnetic part 243 may be mounted on the rotor bracket 241 of each rotor assembly 240, and then, the rotor assemblies 240 may be fixed on the power output shaft 230 in a staggered manner according to the preset staggering angle θk.

The first magnetic part 242 and the second magnetic part 243 may be mounted on the rotor bracket 241 in a built-in manner. Specifically, the rotor bracket 241 may be provided with accommodating holes parallel to the first axis a, and the first magnetic part 242 and the second magnetic part 243 are respectively mounted in the corresponding accommodating holes.

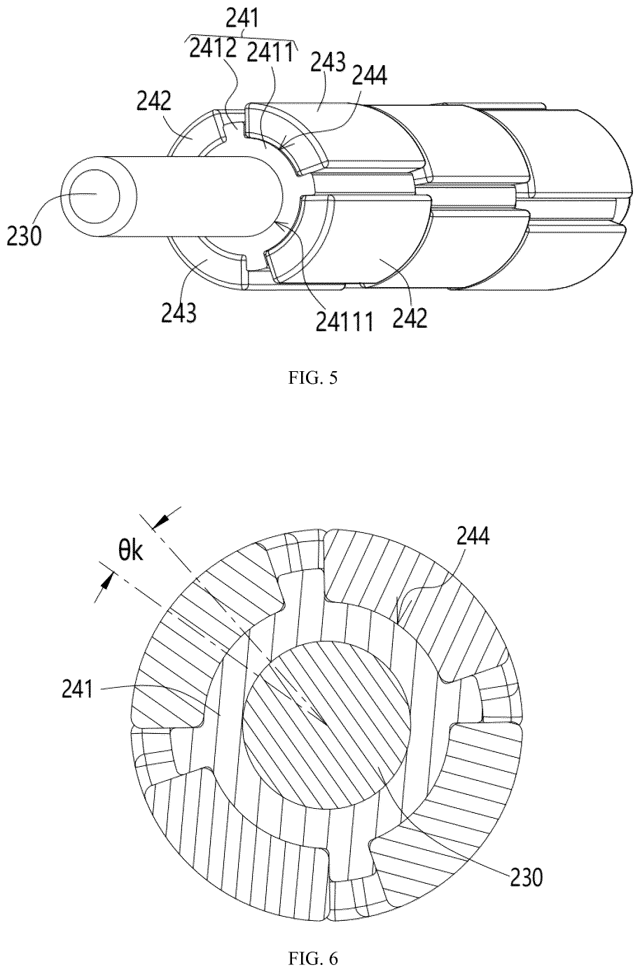

The first magnetic part 242 and the second magnetic part 243 may also be mounted on the rotor bracket 241 in a surface-mounted manner. Specifically, as shown in FIGS. 5 and 6, the rotor bracket 241 includes a base 2411 and at least two positioning rib parts 2412, the base 2411 has a mounting hole 24111, the base 2411 sleeves the power output shaft 230 through the mounting hole 24111, the at least two positioning rib parts 2412 are arranged on an outer circumferential surface of the base 2411 and are arranged in an annular array, every two adjacent positioning rib parts 2412 and the outer circumferential surface of the base 2411 define a magnet groove 244, and the first magnetic part 242 or the second magnetic part 243 is accommodated in each magnet groove 244. In this way, the rotor bracket 241 does not need to extend to outer wall surfaces of the first magnetic part 242 and the second magnetic part 243, such that a volume of the rotor element is smaller, thereby further reducing the volume of the driving apparatus 200 to facilitate the user to grip the brush handle assembly 1000. With this design, a maximum diameter of the rotor assembly 240 is 7 mm±2 mm and a maximum diameter of the driving apparatus 200 is 17.1 mm±10 mm. Moreover, this mounting manner can make gaps between the first magnetic part 242 and the second magnetic part 243 and the stator bracket 220 smaller, thereby increasing the output torque of the driving apparatus 200 and achieving better stability.

In practical applications, the first magnetic part 242 and the second magnetic part 243 may be respectively connected to a bottom surface and/or a side surface of the magnet groove 244 by gluing.

As shown in FIGS. 5 and 6, in an implementable embodiment, a cross section of the first magnetic part 242 and a cross section of the second magnetic part 243 are configured in a fan-ring shape, that is, inner and outer wall surfaces thereof are curved surfaces and are coaxially arranged. In this way, the gaps between the first magnetic part 242 and the second magnetic part 243 and the stator bracket 220 can be smaller, thereby increasing the output torque of the driving apparatus 200 and achieving better stability. It should be noted that the cross section defined in the present application refers to a surface of a corresponding part taken in a plane perpendicular to the first axis a.

In practical applications, the first magnetic part 242 and the second magnetic part 243 have the same shape, and correspondingly, the magnet grooves 244 have the same shape. An inner wall surface of the magnet groove 244 is matched with side surfaces of the inner and outer wall surfaces of the first magnetic part 242 and the second magnetic part 243, such that the inner wall surfaces and side surfaces of the first magnetic part 242 and the second magnetic part 243 can be attached to the bottom surface and the side surface of the magnet groove 244, and mounting stability of the first magnetic part 242 and the second magnetic part 243 is guaranteed.

Since the driving apparatus 200 is mounted in the brush handle assembly 1000 and is limited by a volume requirement of the brush handle assembly 1000, sizes of the power output shaft 230 and the rotor assembly 240 are small, and if the power output shaft 230 is connected with the rotor assembly 240 by means of a slot, supporting strength thereof is prone to be affected. Therefore, in an implementable embodiment, the base 2411 may be in interference connection with the power output shaft 230 through the mounting hole 24111, and/or the base 2411 may be adhesively connected with the power output shaft 230 through the mounting hole 24111, thereby improving the supporting strength.

In another optional embodiment, the power output shaft 230 may include an output shaft body 232 and a transmission shaft 233, the rotor assembly 240 is secured to the output shaft body 232, the output shaft body 232 and the transmission shaft 233 are at least partially engaged, the output shaft body 232 is at least partially located within the shell element 210, and the transmission shaft 233 extends at least partially out of the shell element 210. Thus, the output shaft body 232 can be connected with the nursing head 2000 through the transmission shaft 233, and a groove clamped to the nursing head 2000 is formed in the transmission shaft 233 to avoid slotting on the output shaft body 232, thereby further improving the supporting strength of the output shaft body 232 connected with the rotor assembly 240. The output shaft body 232 does not need to directly support the nursing head 2000, and therefore, the output shaft body 232 may have a smaller diameter to reduce the overall volume of the driving apparatus 200.

In an implementable embodiment, every two adjacent rotor assemblies 240 are attached to each other, that is, the two adjacent rotor assemblies 240 are compressed without a gap. In this way, it is possible to avoid reducing lengths of the first magnetic part 242 and the second magnetic part 243 to ensure the output torque and stability of the driving apparatus 200.

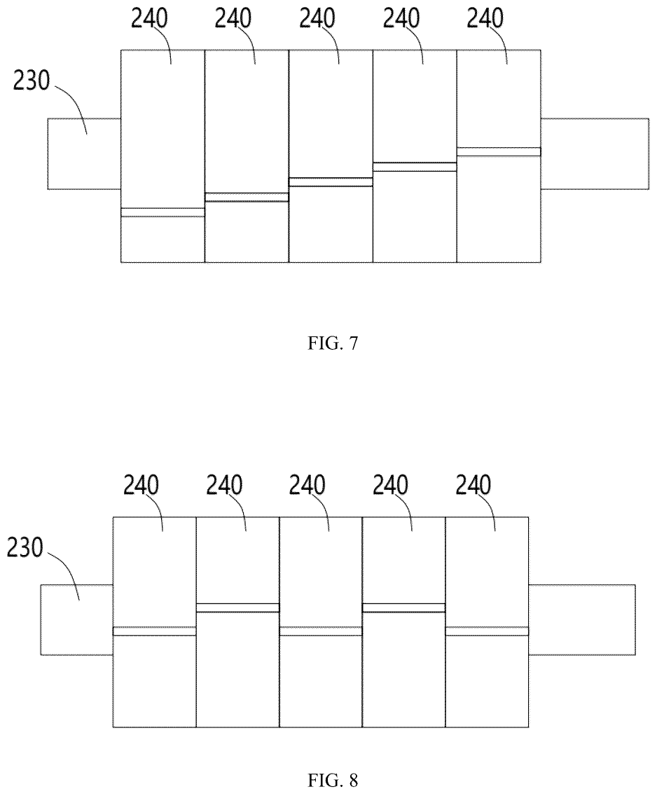

As shown in FIGS. 5 and 7, in an implementable embodiment, the rotor element may have a linear pole staggering design. Specifically, the at least two rotor assemblies 240 are sequentially linearly staggered along the first axis a according to the preset staggering angle θk when viewed along the direction perpendicular to the first axis a.

In order to obtain a best performance of the driving apparatus 200, in the present application, the rotor element is equally segmented. That is, when a length of the rotor element is L and a number of segments is N, a length of each rotor assembly 240 is L/N. Typically, the length L of the rotor element is 10 mm-40 mm. For example, L is 30 mm, the number of the segments N is 3, and the length of each rotor assembly 240 is 30 mm/3=10 mm.

Meanwhile, the preset staggering angle θk is calculated by numbers of corresponding grooves and poles. That is, when the number of the accommodating tooth grooves 221 is b, and a sum of numbers of the first magnetic parts 242 and the second magnetic parts 243 is c, a least common multiple LCM(b, c) of b and c is obtained, the preset staggering angle is θk=(360°/LCM(b, c))/N, and a total oblique pole angle is α=θk*(N−1).

For ease of understanding, the following exemplary description is given with the example that the number of the rotor assemblies 240 is three (N=3), and a 6-groove 4-pole driving apparatus 200 and a 3-groove 2-pole driving apparatus 200 which are commonly used in the oral cleaner are adopted.

When the 6-groove 4-pole driving apparatus 200 is adopted, that is, the number of the accommodating tooth grooves 221 is six (b=6), and each rotor assembly 240 has two first magnetic parts 242 and two second magnetic parts 243 which are staggered (c=4), the preset staggering angle of every two adjacent rotor assemblies 240 is θk=(360°/LCM(b,c))/N=(360°/12)/3=10°, and the total oblique pole angle is α=10°*(3−1)=20°.

When the 3-groove 2-pole driving apparatus 200 is adopted, that is, the number of the accommodating tooth grooves 221 is three (b=3), and each rotor assembly 240 has one first magnetic part 242 and one second magnetic part 243 (c=2), the preset staggering angle of every two adjacent rotor assemblies 240 is θk=(360°/LCM(b, c))/N=(360°/6)/3=20°, and the total oblique pole angle is α=20°*(3−1)=40°.

As shown in FIG. 8, in another optional embodiment, when there are at least four rotor assemblies 240, the at least four rotor assemblies 240 are sequentially staggered when viewed in the direction perpendicular to the first axis a, so as to reduce the cogging torque. For example, the second rotor assembly 240 is rotated counterclockwise by the preset staggering angle θk relative to the first rotor assembly 240, the third rotor assembly 240 is rotated clockwise by the preset staggering angle θk relative to the second rotor assembly 240, the fourth rotor assembly 240 is rotated counterclockwise by the preset staggering angle θk relative to the third rotor assembly 240, and so on.

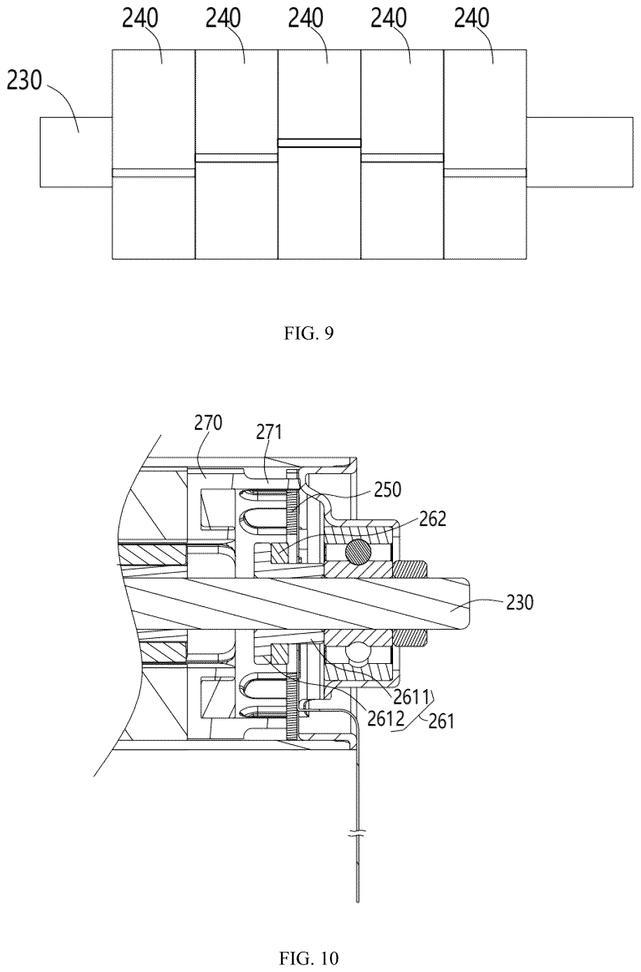

As shown in FIG. 9, in still another optional embodiment, when there are at least three rotor assemblies 240, the at least three rotor assemblies 240 are staggered in a V shape when viewed in the direction perpendicular to the first axis a, so as to reduce the cogging torque. For example, when there are five rotor assemblies 240, the remaining rotor assemblies 240 on both sides of the third rotor assembly 240 are sequentially rotated clockwise or counterclockwise to both sides by the preset staggering angle θk.

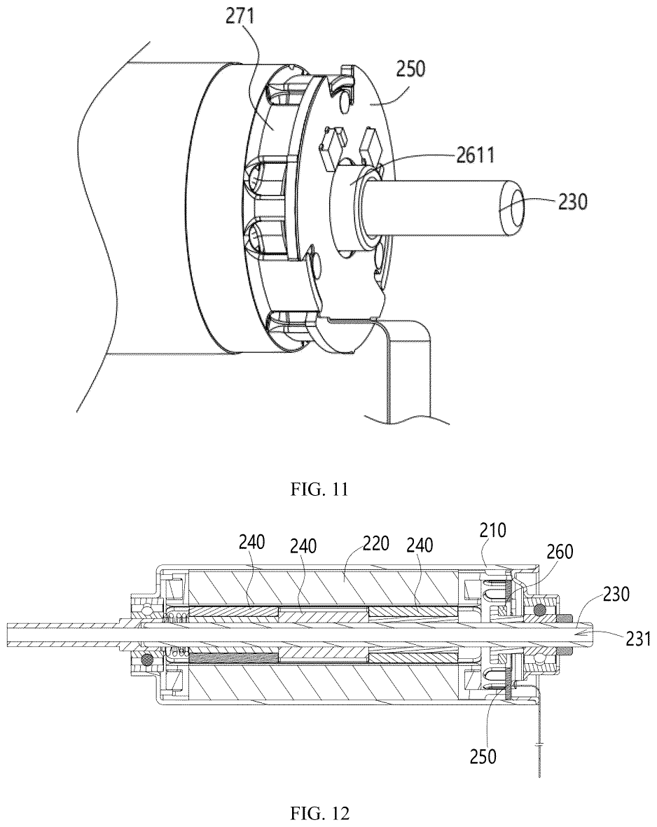

As shown in FIGS. 10 and 11, in an implementable embodiment, the driving apparatus 200 may further include a motion detection component at least partially located in a region surrounded by the static component, and the motion detection component can be configured to detect a rotation speed of the rotary component relative to the static component, and/or detect a rotation position of the rotary component to perform a reversing operation, so as to control the rotary component to reversely rotate at a preset position. The motion detection component includes a motion detection assembly 250 and a motion feedback assembly 260. The motion feedback assembly 260 is accommodated within the shell element 210, and the motion feedback assembly 260 is connected with and rotates along with the rotary component. The motion detection assembly 250 is directly connected with the static component, and the motion detection assembly 250 is at least partially accommodated in the shell element 210, such that the motion detection assembly 250 can determine a position of the rotary component by detecting a position of the motion feedback assembly 260 to achieve the above-described detection function. In practical applications, the motion detection assembly 250 may include a circuit board and a position sensor integrated on the circuit board, and the position sensor may be a laser sensor or a Hall sensor, which is not specifically limited in the present application. The motion detection assembly 250 may be connected to a control assembly outside the static component by a wire harness, such as a wire, a FPC connecting wire, or the like.

It should be noted that, compared with the related art in which the connection of the motion detection assembly 250 and the static component through a corresponding supporting seat requires two positioning and assembling processes, the present application has the advantages that the motion detection assembly 250 in the driving apparatus is directly connected with the static component, such that the motion detection assembly 250 can be positioned and assembled only through one positioning and mounting operation, thus simplifying an assembling process, obviously reducing assembling complexity, solving the problem of a large assembling precision difference caused by multiple times of assembling, then being beneficial to improving the control effect on the cleaning motion of the nursing head 2000, and improving the use experience of the user.

It should be noted that the rotor elements are segmented and staggered at the preset staggering angle θk, so as to weaken the cogging torque, reduce the vibration of the driving apparatus 200, and improve assembly precision in cooperation with the motion detection assembly 250, thus further ensuring detection precision of the motion detection component, and then ensuring the control effect on the cleaning motion of the nursing head 2000.

Meanwhile, the motion detection component formed by the motion detection assembly 250 and the motion feedback assembly 260 is mounted in the shell element 210, such that an outward-expanding structure is prevented from being formed outside the shell element 210, the overall size of the driving apparatus 200 is reduced, a more compact miniaturized design is realized, and therefore, the oral cleaner is slimmer, an aesthetic degree of the electric toothbrush is optimized, a larger water storage space can be reserved inside the oral cleaner to contain more irrigation-brushing liquid, and overall functionality of a product is enhanced.

With respect to a manner in which the motion detection assembly 250 is connected with the static component, three implementable embodiments are provided in the present application for reference.

First embodiment: the motion detection assembly 250 may be directly connected with the shell body 211.

Second embodiment: the motion detection assembly 250 is directly connected with the stator bracket 220.

Third embodiment: as shown in FIGS. 10 and 11, the static component may further include a surface covering element 270. The surface covering element 270 at least partially covers the stator bracket 220 to form an insulating layer to prevent current leakage and an accidental short circuit. The motion detection assembly 250 is directly connected with the surface covering element 270.

It should be noted that the surface covering element 270 is integrated with the stator bracket 220 by injection molding; that is, the surface covering element 270 is formed by injection molding, and manufacturing precision thereof can be higher, such that assembly precision of the motion detection assembly 250 and the surface covering element 270 can be further improved, and then, a control performance of the driving apparatus 200 is improved, thereby further guaranteeing consistency of the swing of the nursing head 2000. The surface covering element 270 may be made of plastic, rubber or thermoplastic elastomer. Therefore, the direct connection of the motion detection assembly 250 and the surface covering element 270 is preferably adopted in the present application, and the following description is also given based on this.

The motion detection assembly 250 may be connected with an inner circumferential wall, an outer circumferential wall, or an end portion of the surface covering element 270.

For convenience of understanding of a specific connection structure of the motion detection assembly 250 and the surface covering element 270, taking the case where the motion detection assembly 250 is connected with the end portion of the surface covering element 270 as an example, in an implementable embodiment, the surface covering element 270 extends along the first axis a, and one end of the surface covering element 270 extends to the outside of the stator bracket 220 to form a joining portion 271, such that the surface covering element 270 is connected with the motion detection assembly 250 through the joining portion 271.

In an implementable embodiment, the motion feedback assembly 260 includes a mounting base 261 and a position feedback part 262. The mounting base 261 has a sleeve 2611 and a support backing plate 2612, and the sleeve 2611 sleeves the power output shaft 230 to rotate with the power output shaft 230. One end of the sleeve 2611 extends through the motion detection assembly 250 to a position between the motion detection assembly 250 and the stator bracket 220, the support backing plate 2612 is located at one end of the sleeve 2611, and the support backing plate 2612 extends radially outwards from an outer wall surface of the sleeve 2611 to form a ring shape. The position feedback part 262 is annular, the position feedback part 262 sleeves the sleeve 2611, and a side of the position feedback part 262 away from the motion detection assembly 250 is attached to and connected with the support backing plate 2612.

It should be noted that one end of the sleeve 2611 passes through the motion detection assembly 250, that is, the motion detection assembly 250 approximatively sleeves the sleeve 2611, and compared to the manner that the motion detection assembly 250 and the motion feedback assembly 260 are spaced apart, in the present application, the sleeve 2611 and the motion detection assembly 250 share a common space along the first axis a, so as to further reduce the volume of the driving apparatus 200 and the volume of the brush handle assembly 1000. Meanwhile, the position feedback part 262 is mounted on the power output shaft 230 through the mounting base 261, such that mounting stability of the position feedback part 262 can be improved, and then, reliability of a result of position detection of the position feedback part 262 by the motion detection assembly 250 can be improved, thereby improving the control effect on a swing process of the nursing head 2000.

In practical applications, the mounting base 261 may be a plastic part or a metal part, such as a copper part, so as to improve structural strength of the mounting base 261 and connection stability between the mounting base 261 and the power output shaft 230. The mounting base 261 and the power output shaft 230 may be connected with each other by a key connection, adhesion, welding, heat shrink, or cold shrink, which is not specifically limited in the present application.

In an implementable embodiment, the Hall sensor is integrated on the circuit board of the motion detection assembly 250, and correspondingly, the position feedback part 262 is a magnetic part, and the motion detection assembly 250 detects the motion position of the position feedback part 262 by magnetic induction to determine the motion position of the rotor element, thereby improving the reliability of the detection result.

In practical applications, the position feedback part 262 has at least two opposite magnetic poles. Correspondingly, two Hall sensors are integrated on the circuit board of the motion detection assembly 250, and the two Hall sensors are spaced apart along a circumference of the first axis a and configured to sense the two opposite magnetic poles of the position feedback part 262. The position feedback part 262 may be formed by connecting two magnets with different magnetic poles, or the two different magnetic poles may be formed by magnetizing different regions of the same magnet, which is not limited herein as long as the magnetic part has two opposite magnetic poles. The two Hall sensors are mounted corresponding to two preset positions of the position feedback part 262 respectively, and the position feedback part 262 can be detected by the corresponding Hall sensor at any preset position, such that the circuit board can control the power output shaft 230 to rotate back and forth between the two preset positions of the position feedback part 262.

As shown in FIG. 2, in an implementable embodiment, bearings are mounted at two ends (for example, the left and right ends in FIG. 2) of the shell element 210 along the extending direction of the first axis a. The power output shaft 230 is rotatably connected with the shell element 210 through the two bearings, the power output shaft 230 is sleeved with a tensioning part 280, the tensioning part 280 has an elastic characteristic, and the tensioning part 280 is located between the rotor element and one of the bearings in a compressed manner. In this way, the elastic characteristic of the tensioning part 280 may provide a necessary preload, so as to maintain tight fit between the bearing and the rotor element, reduce axial movement, avoid an influence on a detection effect of the motion detection component, and improve operation precision of the driving apparatus.

In practical applications, the tensioning part 280 may have an elastic structure, such as a spring or a rubber sleeve, which is not specifically limited in the present application.

Further, the tensioning part 280 and the motion detection component may be located at two opposite ends of the rotor element in the extending direction of the first axis a, and the distributed layout realizes rationalization and optimal utilization of an internal space of the driving apparatus. Meanwhile, the arrangement of the tensioning part 280 and the motion detection component along the two ends of the first axis a helps to reduce potential electromagnetic interference of the tensioning part on detection precision of a motion detection unit.

As shown in FIG. 2, the driving apparatus 200 may have only a driving function, and correspondingly, the power output shaft 230 has a solid structure, the power output shaft 230 drives the nursing head 2000 to move, the nursing head 2000 may be a brush head having a cleaning portion, and the cleaning portion may be bristles or other cleaning parts.

The driving apparatus 200 may have the driving function and serve as a fluid conveying structure. Specifically, as shown in FIGS. 1 and 12, in an implementable embodiment, the brush handle assembly 1000 further includes a liquid storage chamber 400 and a fluid pumping unit 500, and the liquid storage chamber 400 and the fluid pumping unit 500 are located within the accommodating space 110. The power output shaft 230 has an axial channel 231, as well as a fluid inlet and a fluid outlet communicated with the axial channel 231, the fluid inlet of the axial channel 231 may be communicated with the liquid storage chamber 400, and the fluid pumping unit 500 is connected in series in a flow channel for communicating the fluid inlet of the axial channel 231 with the liquid storage chamber 400, such that the fluid pumping unit 500 may draw fluid in the liquid storage chamber 400 and allow the fluid to flow out of the fluid outlet of the axial channel 231 through the axial channel 231. Correspondingly, the nursing head 2000 has a fluid channel 2100 and an outflow opening 2200 communicated with the fluid channel 2100, the power output shaft 230 is connected with the nursing head 2000 and drives the nursing head 2000 to perform a displacement motion, the fluid outlet of the axial channel 231 is communicated with the fluid channel 2100, and the oral cleaner outputs a water flow impact through the outflow opening 2200.

In practical applications, the nursing head 2000 may be a multifunctional brush head integrated with the cleaning portion and the outflow opening 2200, such that the user may perform an irrigation operation while performing brushing or flexibly switch brushing and irrigation during oral cleaning. Certainly, the nursing head 2000 may be a general term for a brush head having the cleaning portion and a brush head having the outflow opening 2200, and the brush head having the cleaning portion is mounted on the brush handle assembly 1000 for the brushing operation or the brush head having the outflow opening 2200 is mounted on the brush handle assembly 1000 for the irrigation operation according to actual use requirements of the user.

Based on the same inventive concept, the present application also provides a driving apparatus for oral cleaning, including at least a static component and a rotary component, wherein the static component extends along a first axis a, the static component includes a shell element 210 and a stator bracket 220 accommodated in the shell element 210, an inner wall surface of the stator bracket 220 is provided with a plurality of accommodating tooth grooves 221 arranged around the first axis a, and an extending direction of the accommodating tooth grooves 221 is parallel to the first axis a. The rotary component includes a power output shaft 230 and at least two rotor assemblies 240 located in the stator bracket 220, the power output shaft 230 extends along the first axis a and is rotatably connected with the shell element 210, the at least two rotor assemblies 240 sleeve the power output shaft 230 and are sequentially stacked along the first axis a, and when viewed from a section perpendicular to the first axis a, every two adjacent rotor assemblies 240 have a preset staggering angle θk.

Further, the driving apparatus 200 further includes a motion detection assembly 250 and a motion feedback assembly 260, wherein the motion detection assembly 250 is directly connected with the static component and at least partially accommodated in the shell element 210; the motion feedback assembly 260 is accommodated in the shell element 210, the motion feedback assembly 260 is connected with the rotary component and rotates along with the rotary component, and the motion detection assembly 250 detects a motion position of the rotary component through the motion feedback assembly 260.

Further, the power output shaft 230 includes an output shaft body 232 and a transmission shaft 233, the output shaft body 232 and the transmission shaft 233 are at least partially engaged, the output shaft body 232 is at least partially located within the shell element 210, and the transmission shaft 233 extends at least partially out of the shell element 210.

It should be noted that, for specific structures of the static component, the rotary component, the motion detection assembly 250 and the motion feedback assembly 260, reference may be made to the content of the above embodiments, and details are not repeated herein.

Based on the same inventive concept, the present application also provides a brush handle assembly, wherein the brush handle assembly 1000 can be a separate component, the brush handle assembly 1000 includes a grip housing 100 having an accommodating space 110, and the accommodating space 110 is provided therein with an energy storage component 300 and the above driving apparatus 200 for oral cleaning.

It should be noted that, for a specific structure of the driving apparatus 200, reference may be made to the content of the above embodiment, and details are not repeated herein.

The terms “upper”, “lower”, or the like, are used for describing relative position relationships of structures in the drawings, are used only for clarity of description, and are not intended to limit the scope of implementation of the present application, and changes or adjustments of the relative relationships, without substantial alteration of the technical content, should also be regarded as within the scope of implementation of the present application.

It should be noted that, in the present application, unless specified or limited otherwise, a structure in which a first feature is “on” or “below” a second feature may include an embodiment in which the first feature is in direct contact with the second feature, and may also include an embodiment in which the first feature and the second feature are contacted via an additional feature formed therebetween. Furthermore, a first feature “on”, “above” and “over” a second feature may be directly on or obliquely above the second feature, or simply mean that the first feature is at a higher level than the second feature. A first feature “under”, “below” and “beneath” a second feature may be directly under or obliquely below the second feature, or simply mean that the first feature is at a lower level than the second feature.

Furthermore, in the present application, unless specified or limited otherwise, the terms “mounted”, “connected”, “coupled”, and “fixed” and the like are used broadly, and may be, for example, fixed connections, detachable connections, or integral connections; may also be direct connections or indirect connections via intervening structures; may also be communication or an interaction relationship of two elements. The above terms can be understood by those skilled in the art according to specific situations.

In the description of the specification, references to “an embodiment”, “some embodiments”, “exemplary embodiments”, “examples”, “specific examples”, “some examples”, or the like, mean that a particular feature, structure, material, or characteristic described in connection with the embodiment or example is included in at least one embodiment or example of the present disclosure. In this specification, schematic depictions of the above terms do not necessarily refer to the same embodiment or example. Furthermore, the described particular features, structures, materials, or characteristics may be combined in any suitable manner in one or more embodiments or examples.

Finally, it should be noted that the above embodiments are only used to illustrate the technical solutions of the present application, not to limit the present application; although the present application is described in detail with reference to the above embodiments, those having ordinary skill in the art should understand that they still can modify technical solutions recited in the aforesaid embodiments or equivalently replace partial or all technical features therein; these modifications or substitutions do not make essence of corresponding technical solutions depart from the scope of technical solutions of embodiments of the present application.

What is claimed is:

1. An oral cleaner, comprising a brush handle assembly (1000) and a nursing head (2000), wherein the brush handle assembly (1000) comprises a grip housing (100) having an accommodating space (110) as well as a driving apparatus (200) and an energy storage component (300) which are arranged in the accommodating space (110), and the nursing head (2000) has a cleaning portion at a distal end thereof; the brush handle assembly (1000) is removably coupled with the nursing head (2000);
the driving apparatus (200) is configured to generate a periodic motion; the driving apparatus (200) extending along a first axis (a) at least comprises:
a static component comprising a shell element (210) and a stator bracket (220) accommodated in the shell element (210), an inner wall surface of the stator bracket (220) being provided with a plurality of accommodating tooth grooves (221) arranged around the first axis (a), and an extending direction of the accommodating tooth grooves (221) being parallel to the first axis (a);
a rotary component comprising a power output shaft (230) and at least two rotor assemblies (240) located within the stator bracket (220), the power output shaft (230) being at least partially contained within the brush handle assembly (1000) and configured to be engaged with the nursing head (2000); the power output shaft (230) being configured to transmit the generated periodic motion to the nursing head (2000), such that the cleaning portion rotates periodically at least in a first direction, and the first direction is around the first axis (a); the power output shaft (230) extending along the first axis (a) and being rotatably connected with the shell element (210), the at least two rotor assemblies (240) sleeving the power output shaft (230) and being sequentially stacked along the first axis (a), and every two adjacent rotor assemblies (240) having a preset staggering angle (θk) when viewed from a section perpendicular to the first axis (a).

2. The oral cleaner according to claim 1, wherein the rotor assembly (240) comprises a rotor bracket (241), a first magnetic part (242) and a second magnetic part (243) with opposite magnetism to the first magnetic part (242),
the rotor bracket (241) comprises a base (2411) and at least two positioning rib parts (2412), the base (2411) has a mounting hole (24111), the base (2411) sleeves the power output shaft (230) through the mounting hole (24111), the at least two positioning rib parts (2412) are arranged on an outer circumferential surface of the base (2411) and are arranged in an annular array, every two adjacent positioning rib parts (2412) and the outer circumferential surface of the base (2411) define a magnet groove (244), and the first magnetic part (242) or the second magnetic part (243) is accommodated in each magnet groove (244).

3. The oral cleaner according to claim 2, wherein a cross section of the first magnetic part (242) and a cross section of the second magnetic part (243) are configured in a fan-ring shape.

4. The oral cleaner according to claim 2, wherein the base (2411) is in interference connection with the power output shaft (230) through the mounting hole (24111), and/or the base (2411) is adhesively connected with the power output shaft (230) through the mounting hole (24111).

5. The oral cleaner according to claim 2, wherein every two adjacent rotor assemblies (240) are attached to each other.

6. The oral cleaner according to claim 2, wherein the at least two rotor assemblies (240) are sequentially linearly staggered along the first axis (a) according to the preset staggering angle (θk) when viewed along a direction perpendicular to the first axis (a).

7. The oral cleaner according to claim 6, wherein three rotor assemblies (240) are provided, six accommodating tooth grooves (221) are provided, each rotor assembly (240) has two first magnetic parts (242) and two second magnetic parts (243) which are staggered, and the preset staggering angle (θk) of every two adjacent rotor assemblies (240) is 10°.

8. The oral cleaner according to claim 6, wherein three rotor assemblies (240) are provided, three accommodating tooth grooves (221) are provided, each rotor assembly (240) has one first magnetic part (242) and one second magnetic part (243), and the preset staggering angle (θk) of every two adjacent rotor assemblies (240) is 20°.

9. The oral cleaner according to claim 1, wherein at least four rotor assemblies (240) are provided;
the at least four rotor assemblies (240) are sequentially staggered when viewed along the direction perpendicular to the first axis (a).

10. The oral cleaner according to claim 1, wherein at least three rotor assemblies (240) are provided;
the at least three rotor assemblies (240) are staggered in a V shape when viewed along the direction perpendicular to the first axis (a).

11. The oral cleaner according to claim 1, wherein a maximum diameter of the rotor assembly (240) is 7 mm±2 mm and a maximum diameter of the driving apparatus (200) is 17.1 mm±10 mm.

12. The oral cleaner according to claim 1, wherein the driving apparatus (200) further comprises a motion detection assembly (250) and a motion feedback assembly (260),
the motion detection assembly (250) is directly connected with the static component and at least partially accommodated in the shell element (210);
the motion feedback assembly (260) is accommodated in the shell element (210), the motion feedback assembly (260) is connected with the rotary component and rotates along with the rotary component, and the motion detection assembly (250) detects a motion position of the rotary component through the motion feedback assembly (260).

13. The oral cleaner according to claim 12, wherein the static component further comprises a surface covering element (270);
the surface covering element (270) at least partially covers the stator bracket (220), the surface covering element (270) extends along the first axis (a), and one end of the surface covering element (270) extends to the outside of the stator bracket (220) to form a joining portion (271), such that the surface covering element (270) is connected with the motion detection assembly (250) through the joining portion (271).

14. The oral cleaner according to claim 12, wherein the motion feedback assembly (260) comprises a mounting base (261) and a position feedback part (262);
the mounting base (261) has a sleeve (2611) and a support backing plate (2612), the sleeve (2611) sleeves the power output shaft (230), one end of the sleeve (2611) extends through the motion detection assembly (250) to a position between the motion detection assembly (250) and the stator bracket (220), the support backing plate (2612) is located at one end of the sleeve (2611), and the support backing plate (2612) extends radially outwards from an outer wall surface of the sleeve (2611) to form a ring shape;
the annular position feedback part (262) sleeves the sleeve (2611), and a side of the position feedback part (262) away from the motion detection assembly (250) is attached to and connected with the support backing plate (2612).

15. The oral cleaner according to claim 1, wherein the brush handle assembly (1000) further comprises a liquid storage chamber (400) and a fluid pumping unit (500) located within the accommodating space (110);
the power output shaft (230) has an axial channel (231), as well as a fluid inlet and a fluid outlet communicated with the axial channel (231), the fluid inlet of the axial channel (231) can be communicated with the liquid storage chamber (400), and the fluid pumping unit (500) is connected in series in a flow channel for communicating the fluid inlet of the axial channel (231) with the liquid storage chamber (400), such that the fluid pumping unit (500) can draw fluid in the liquid storage chamber (400) and allow the fluid to flow out of the fluid outlet of the axial channel (231) through the axial channel (231);
the nursing head (2000) has a fluid channel (2100) and an outflow opening (2200) communicated with the fluid channel (2100), the power output shaft (230) is connected with the nursing head (2000) and drives the nursing head (2000) to perform a displacement motion, the fluid outlet of the axial channel (231) is communicated with the fluid channel (2100), and the oral cleaner outputs a water flow impact through the outflow opening (2200).

16. A driving apparatus for oral cleaning, at least comprising:
a static component extending along a first axis (a) and comprising a shell element (210) and a stator bracket (220) accommodated in the shell element (210), an inner wall surface of the stator bracket (220) being provided with a plurality of accommodating tooth grooves (221) arranged around the first axis (a), and an extending direction of the accommodating tooth grooves (221) being parallel to the first axis (a);
a rotary component comprising a power output shaft (230) and at least two rotor assemblies (240) located within the stator bracket (220), the power output shaft (230) extending along the first axis (a) and being rotatably connected with the shell element (210), the at least two rotor assemblies (240) sleeving the power output shaft (230) and being sequentially stacked along the first axis (a), and every two adjacent rotor assemblies (240) having a preset staggering angle (θk) when viewed from a section perpendicular to the first axis (a).

17. The driving apparatus for oral cleaning according to claim 16, wherein the driving apparatus (200) further comprises a motion detection assembly (250) and a motion feedback assembly (260),
the motion detection assembly (250) is directly connected with the static component and at least partially accommodated in the shell element (210);
the motion feedback assembly (260) is accommodated in the shell element (210), the motion feedback assembly (260) is connected with the rotary component and rotates along with the rotary component, and the motion detection assembly (250) detects a motion position of the rotary component through the motion feedback assembly (260).

18. The driving apparatus for oral cleaning according to claim 16, wherein the power output shaft (230) comprises an output shaft body (232) and a transmission shaft (233), the output shaft body (232) and the transmission shaft (233) are at least partially engaged, the output shaft body (232) is at least partially located within the shell element (210), and the transmission shaft (233) extends at least partially out of the shell element (210).
